(19) United States
(12) Patent Application Publication
(10) Pub. No.: US 2026/0328470 A1
(43) Pub. Date: Oct. 22, 2026

(54) REFRIGERATOR

(71) Applicants: HEFEI MIDEA REFRIGERATOR CO., LTD., HEFEI (CN); HEFEI HUALING CO., LTD., HEFEI (CN); MIDEA GROUP CO., LTD., FOSHAN (CN)

(72) Inventors: Yafei ZHU, HEFEI (CN); Bo PENG, HEFEI (CN); Bing SHI, HEFEI (CN); Jinguo YUAN, HEFEI (CN); Chuandong WANG, HEFEI (CN); Shenghao QI, HEFEI (CN); Ronghai CHEN, HEFEI (CN); Zhuohua JIANG, HEFEI (CN); Xiuliang FU, HEFEI (CN); Yerui FENG, HEFEI (CN)

(21) Appl. No.: 19/111,302

(22) PCT Filed: Jun. 25, 2023
(86) PCT No.: PCT/CN2023/102101

§ 371 Date: Mar. 12, 2025

(30) Foreign Application Priority Data
Sep. 20, 2022 (CN) 202211145445.X

(51) Int. Cl. F25D 23/02; F25D 11/00

(52) U.S. Cl. CPC F25D 23/028; F25D 11/00

(57) ABSTRACT

A refrigerator, including: a box body opened with an accommodation space with an opening; a door body rotatably connected to the box body to enclose or open the opening; a door rotation mechanism connected to the door body 13; a driver disposed on the box body; a linkage wheel rotatably disposed on the box body, and connected to the driver and the door rotation mechanism, and in a condition that the driver is activated, the linkage wheel rotates to drive the door rotation mechanism to drive the door body to rotate; and a suspension device including a first engaging portion that is disposed on the linkage wheel and a second engaging portion that is disposed on the box body, where the linkage wheel rotates to drive the first engaging portion to be opposite to and engaged with the second engaging portion, to prevent the door rotation mechanism from rotating the door body.

### CROSS-REFERENCES TO RELATED APPLICATIONS

The present disclosure is a national phase application of International Application No. PCT/CN2023/102101, filed Jun. 25, 2023, which claims priority to Chinese patent application No. 202211145445.X, filed on Sep. 20, 2022, the entire contents of which are incorporated herein by reference.

### FIELD

The disclosure belongs to a field of electrical apparatus, and in particular relates to a refrigerator.

### BACKGROUND

With the improvement of living standards, electrical apparatuses such as refrigerators, dishwashers and disinfection cabinets have become widely used in lives of people. In order to maintain a sealing performance of the above-mentioned electrical apparatuses, an adsorption structure is usually provided between a box body and a door body thereof or negative pressure is maintained within the box body, to stably fix the door body on the box body. Although a related performance of the electrical apparatus is improved in this way, a difficulty of opening the door body is also increased to a certain extent. Since a larger force is usually required to open the door body, it is inconvenient to use. To this end, a door opening and closing device can be provided to implement operations of opening and closing a door to reduce a difficulty of operations of opening and closing the door. However, in order to avoid interferences of operations, after the door body reaches a preset opening, the door opening and closing device will stop outputting a driving force. Under an influence of safety measure of the door body or influences of factors such as ground unevenness and the like, the door body will rotate toward a direction enclosing the box body, and thus cannot maintain in a door open state, to cause an inconvenience in use and even create certain safety risks.

### SUMMARY

The disclosure provides a refrigerator, which is intended to at least to some extent solve a problem that a door opening and closing device of the refrigerator after being shut down cannot maintain a door open state.

A refrigerator is provided according to some embodiments of the disclosure, including: a box body opened with an accommodation space with an opening; a door body rotatably connected to the box body to enclose or open the opening; a door rotation mechanism connected to the door body; a driver disposed on the box body; a linkage wheel rotatably disposed on the box body, and connected to the driver and the door rotation mechanism, and in a condition that the driver is activated, the linkage wheel rotates to drive the door rotation mechanism to drive the door body to rotate; and a suspension device including a first engaging portion that is disposed on the linkage wheel and a second engaging portion that is disposed on the box body, where the linkage wheel rotates to drive the first engaging portion to be opposite to and engaged with the second engaging portion, to prevent the door rotation mechanism from rotating the door body.

### BRIEF DESCRIPTION OF THE DRAWINGS

In order to more clearly illustrate the embodiments of the disclosure, the following briefly introduces the accompanying drawings required for describing the embodiments. The accompanying drawings in the following description only illustrate some embodiments of the disclosure, and other accompanying drawings can also be obtained based on these accompanying drawings.

FIG. 1 shows a schematic assembly structural diagram of a door opening and closing device in a refrigerator according to some embodiments of the disclosure;

FIG. 2 shows a schematic structural diagram of the door opening and closing device in FIG. 1 in a suspension condition;

FIG. 3 shows a schematic structural diagram of a suspension mechanism of the door opening and closing device in FIG. 1;

FIG. 4 shows a schematic structural diagram of a linkage wheel of the door opening and closing device in FIG. 3;

FIG. 5 is a schematic diagram showing a cooperation of a suspension member and a push-ejection member of the door opening and closing device in FIG. 3;

FIG. 6 shows a schematic structural diagram of a suspension limit slide slot of the door opening and closing device in FIG. 3;

FIG. 7 is a schematic diagram showing a cooperation of the suspension member and the suspension limit slide slot of the door opening and closing device in FIG. 3;

FIG. 8 is a schematic diagram showing an initial state of a door ejection mechanism of the door opening and closing device in FIG. 3;

FIG. 9 is a schematic diagram showing a door ejection state of the door ejection mechanism of the door opening and closing device in FIG. 3;

FIG. 10 is a schematic diagram showing an initial state of the door ejection mechanism of the door opening and closing device in FIG. 3;

FIG. 11 shows a schematic structural diagram of the door ejection mechanism of the door opening and closing device in FIG. 3;

FIG. 12 is a schematic assembly structural diagram of another door ejection mechanism of the door opening and closing device in FIG. 3;

FIG. 13 is a schematic structural diagram showing a door ejection state of the door ejection mechanism of the door opening and closing device in FIG. 12;

FIG. 14 is a schematic structural diagram showing a suspended state of the door ejection mechanism of the door opening and closing device in FIG. 12;

FIG. 15 is a schematic structural diagram of a linkage wheel of the door opening and closing device in FIG. 12;

FIG. 16 is a schematic assembly structural diagram of another door opening and closing device of the refrigerator according to some embodiments of the disclosure;

FIG. 17 is a schematic structural diagram of a linkage wheel and a suspension mechanism of the door opening and closing device in FIG. 16;

FIG. 18 is a schematic structural diagram of a limit mechanism of the door opening and closing device in FIG. 16;

FIG. 19 is a schematic structural diagram showing an initial state of a door opening and closing device in FIG. 18;

FIG. 20 is a schematic structural diagram showing a door ejection state of the suspension mechanism of the door opening and closing device in FIG. 19;

FIG. 21 is a schematic structural diagram showing a suspended state of the door opening and closing device in FIG. 19;

FIG. 22 is a schematic diagram showing an initial state of a door ejection mechanism of yet another door opening and closing device according to some embodiments of the disclosure;

FIG. 23 is a schematic diagram showing a door ejection state of the door ejection mechanism of the door opening and closing device in FIG. 22;

FIG. 24 is a schematic diagram showing a suspended state of the door ejection mechanism of the door opening and closing device in FIG. 22; and

FIG. 25 is a schematic structural diagram of a linkage wheel and a suspension mechanism of the door opening and closing device in FIG. 22.

In the accompanying drawings, corresponding relationships between reference signs and component names are as follows:
1000, driver;
10, refrigerator; 11, door opening and closing device; 12, box body; 13, door body;
300, linkage wheel; 310, abutting-holding portion; 312, door ejection surface; 314, avoidance surface; 316, connection point; 320, limit structure; 320a, groove; 350, door ejection portion; 351, door ejection point; 352, exterior surface;
400, door rotation mechanism; 410, front connection rod; 420, rear connection rod;
500, door ejection mechanism; 510, elastic reset member; 520, door ejection member;
600, suspension device; 600 a, first engaging portion; 600b, second engaging portion; 610, suspension member; 611, ejecting-abutting portion; 612, push-ejection limit slot; 620, push-ejection member; 620a, elastic member; 630, suspension mechanism; 631, connecting portion; 631a, connecting arm; 632, suspension portion; 632a, snapping-embedding member; 632a1, snapping-embedding head; 633, reinforcing rib plate; 640, limit mechanism; 641, guide portion; 641a, guide plane; 642, limit portion; 643, limit groove;
900, base; 906, suspension limit slide slot; 907, limit boss; 908, support socket; 909, boss portion; 912, mounting groove.

### DETAILED DESCRIPTION OF THE DISCLOSURE

The embodiments of the disclosure will be clearly and completely described below with reference to the accompanying drawings in the embodiments of the disclosure. The described embodiments are only some embodiments, rather than all embodiments of the disclosure. Based on the embodiments in the disclosure, all other embodiments fall within the protection scope sought by the disclosure.

Furthermore, the disclosure may repeat reference numerals and/or reference letters in different examples. Such repetition is for the purpose of simplicity and clarity and does not in itself indicate a relationship between the various embodiments and/or settings discussed. Furthermore, the disclosure provides examples of various specific processes and materials, but it may be recognized the application of other processes and/or the use of other materials.

The disclosure is described below with reference to the accompanying drawings and embodiments.

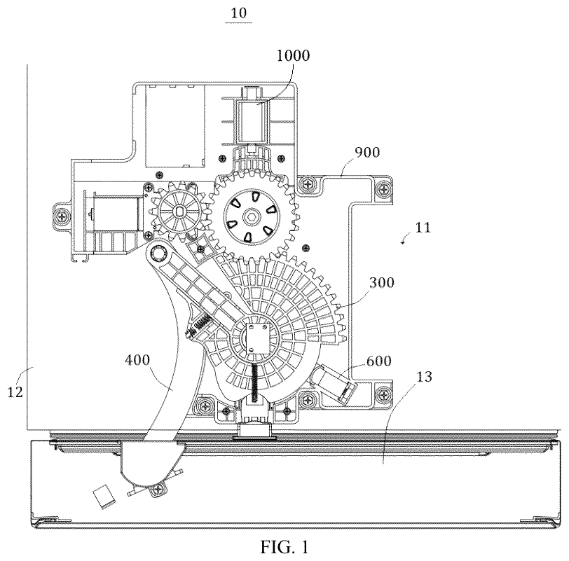

FIG. 1 is a schematic assembly structural diagram of a door opening and closing device in a refrigerator according to some embodiments of the disclosure. As shown in FIG. 1, a refrigerator 10 is provided according to some embodiments of the disclosure. The refrigerator 10 is provided with a door opening and closing device 11 to realize a function of automatic door opening and closing, and improve an automation degree of door opening and closing of the refrigerator to a certain extent, and thus improve a convenience of operation, and reduce a difficulty of operation. The door opening and closing device 11 is mounted onto a box body 12 and connected to a door body 13 of the refrigerator. The door opening and closing device 11 pushes and pulls the door body 13 to deflect the door body 13 relative to the box body 12, to close and open the box body 12, and thus a convenience of operation is improved. The door opening and closing device 11 can also maintain an opening of the door body 13 after the door body 13 reaches a preset opening, to improve a comfort of use and avoid a safety risk of collision to an operator caused by the door body closing automatically. Generally speaking, components of the door opening and closing device 11 can be directly disposed on the box body 12, and a base 900 can be further provided as a basis for bearing various functional components in the door opening and closing device 11, to fix the door opening and closing device 11 as a whole on the box body 12, to implement an overall assembly of the door opening and closing device 11.

The door opening and closing device 11, after receiving a door opening signal, can automatically open the door body 13. In some embodiments, the door opening signal may be triggered by a user or by the refrigerator itself. Likewise, the door opening and closing device 11, after receiving a door closing signal, can automatically close the door body 13. In some embodiments, the door closing signal may be triggered by a user or by the refrigerator itself.

In some embodiments of the disclosure, the refrigerator 10 may include a box body 12 and a door body 13. The box body 12 may be opened with an accommodation space having an opening. The opening may be enclosed or opened by the door body 13 that is rotatably connected to the box body 12 to implement the closing or opening of the door. The door opening and closing device 11 may be mounted on the box body 12, and the door opening and closing device 11 is connected to the door body 13, to automatically push and pull the door body 13, to cause the door body 13 to rotate relative to the box body 12, to realize automatic door opening and closing.

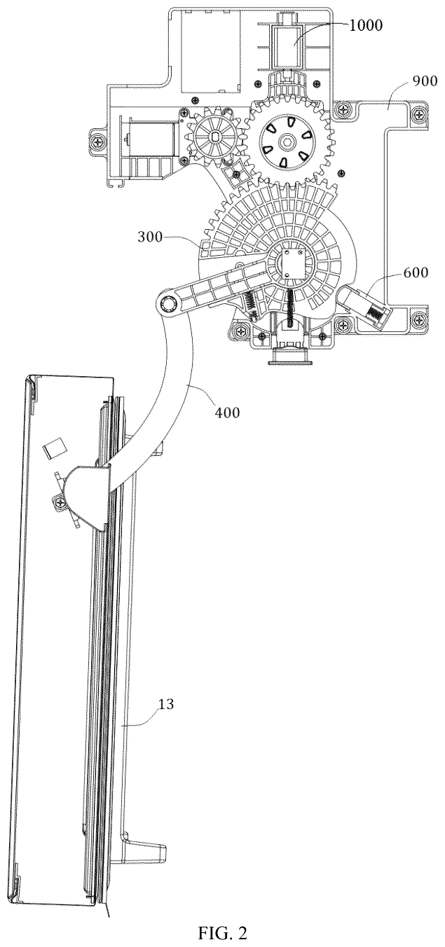

FIG. 2 shows a schematic structural diagram of the door opening and closing device in FIG. 1 in a suspension condition. As shown in FIG. 1 and FIG. 2, the door opening and closing device 11 may include: a door rotation mechanism 400, a driver 1000 and a linkage wheel 300. In some embodiments, the linkage wheel 300 is rotatably disposed on the box body 12 and is connected to the driver 1000 and the door rotation mechanism 400, and thus in a condition that the driver 1000 is activated, the linkage wheel 300 is driven to rotate to drive the door rotation mechanism 400 to drive the door body 13 to rotate, to implement operations of door opening and closing. In some embodiments of the disclosure, by providing the door rotation mechanism 400 and the linkage wheel 300, the door body 13 is rotated under a drive of the driver 1000 to realize automatic door opening and closing, to reduce a difficulty of manual operation of door opening, and to improve convenience and comfort.

When the door body rotates to a preset door opening position, the driver 1000 will no longer apply a driving force to leave a space for a manual operation of the door body 13, and avoid interference with the manual operation of the door body 13. However, the door body 13 will also be closed under an action of self-locking guide force for door closing thereof, and thus an opening of the door body 13 cannot be maintained. Therefore, it is inconvenient to use, and a safety risk of collision is even caused to an operator.

In some embodiments, in order to solve the problem that the door body 13 cannot maintain an opening when the door opening and closing device is shut down, a suspension device 600 may be provided to brake the door rotation mechanism 400, to maintain the opening when the door body 13 is in an open state. The suspension device 600 may include a first engaging portion 600a disposed on the linkage wheel 300 and a second engaging portion 600b disposed on the box body 12 or the base 900. When the linkage wheel 300 rotates to make the first engaging portion 600a and the second engaging portion 600b opposite, the first engaging portion 600a engages with the second engaging portion 600b, to brake the linkage wheel 300 to prevent the door rotation mechanism 400 from rotating the door body 13.

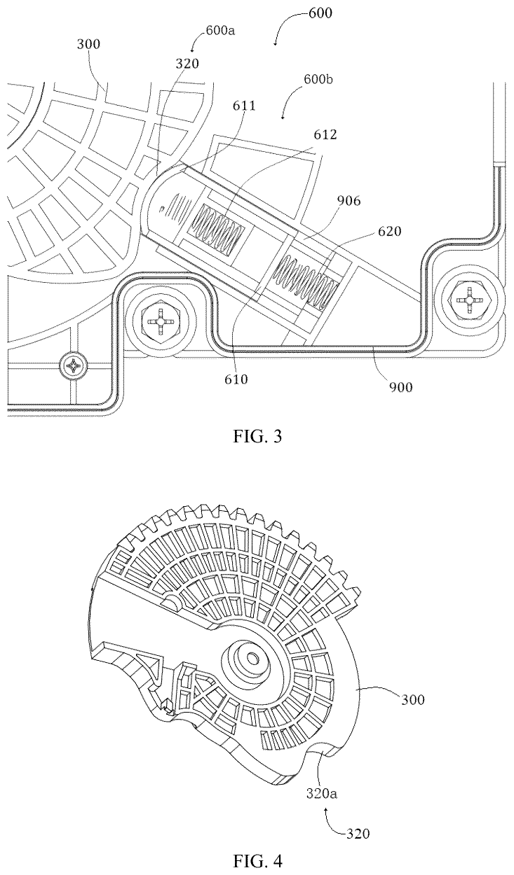

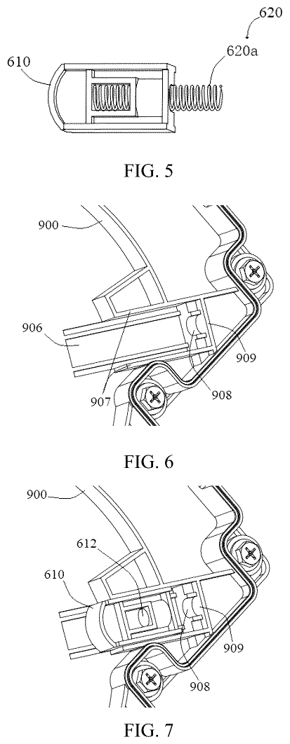

FIG. 3 shows a schematic structural diagram of a suspension mechanism of the door opening and closing device in FIG. 1; FIG. 4 shows a schematic structural diagram of a linkage wheel of the door opening and closing device in FIG. 3; and FIG. 5 is a schematic diagram showing a cooperation of a suspension member and a push-ejection member of the door opening and closing device in FIG. 3.

As shown in FIG. 3, FIG. 4 and FIG. 5, in order to solve the problem that the door body 13 cannot maintain an opening when the door opening and closing device is shut down, the first engaging portion 600a may include a limit structure 320 formed on the linkage wheel 300, and the second engaging portion 600b may include a suspension member 610 and a push-ejection member 620. The suspension member 610 is movably disposed on the base 900, and continuously ejects and abuts against the linkage wheel 300, and can match with, eject and abut against, and clamp the limit structure 320, and thus when the linkage wheel 300 makes the limit structure 320 in a state opposite to the suspension member 610, the suspension member 610 can move toward the linkage wheel 300 and eject and abut against the limit structure 320, to lock the linkage wheel 300 on the base 900 to achieve a braking of the linkage wheel 300. The push-ejection member 620, as a driving element of the suspension member 610, continuously provides a pushing and ejecting force to the suspension member 610, to push and eject the suspension member 610 toward the linkage wheel 300, to be capable of pushing and ejecting the suspension member 610 and the limit structure 320 to eject and abut against the linkage wheel 300 for braking.

It should be noted that, the suspension member 610, under an action of continuous pushing and ejecting force, always maintains a state of abutting against the linkage wheel 300. During a rotation of the linkage wheel 300, the suspension member 610 slides on the linkage wheel 300. Only in a condition that the linkage wheel 300 rotates to a state in which the limit structure 320 is opposite to the suspension device 600, the suspension member 610 moves, and ejects and abuts into the limit structure 320 under the action of the pushing and ejecting force, to brake the linkage wheel 300. The continuous pushing and ejecting force enables the suspension member 610 to track a position of rotating periphery surface of the linkage wheel 300 and respond to a position of the limit structure 320 in a timely manner. That is, after the limit structure 320 and the suspension device 600 are in corresponding positions, the suspension member 610 immediately ejects and abuts against and clamps the limit structure 320. An ejecting-abutting portion 611 may be disposed on the suspension member 610 for contacting, ejecting and abutting against the limit structure 320, and may be ejected and abutted into an interior of the limit structure 320 to implement contacting, ejecting and abutting for braking.

When the linkage wheel 300 rotates to a certain position to make the limit structure 320 in a state opposite to the suspension member 610, the suspension member 610 moves and then ejects and abuts against the limit structure 320, to lock the linkage wheel 300 on the base 900, to prevent the door rotation mechanism 400 from rotating the door body 13, to achieve a suspension of the door body 13 and maintain a preset opening position.

That is to say, the limit structure 320 rotates with the linkage wheel 300. The suspension member 610 can move relative to the base 900, and can change a movement state of the suspension member 610 in response to a rotation of the linkage wheel 300. Thus, when the limit structure 320 rotates to a position where the limit structure 320 matches with and is opposite to the suspension device 600, the suspension device 600 can eject and abut against, and clamp the limit structure 320, to lock the linkage wheel 300 and limit a rotation of the linkage wheel 300, and thus the door rotation mechanism 400 can be braked to prevent the door body 13 from deflecting, to keep the door body 13 suspended at a preset position.

It is worth mentioning that a state of ejecting and abutting against for locking of the suspension member 610 and the limit structure 320 is a reversible state. When an external driving force applied to the linkage wheel 300 is greater than a braking force between the suspension member 610 and the limit structure 320, the linkage wheel 300 breaks through an action of ejecting and abutting against for limiting and continues to rotate. The linkage wheel 300, a braking state of which is released, can drive the door rotation mechanism 400 to rotate the door body 13 to be closed, or can further expand an opening of the door body 13.

As shown in FIG. 3 and FIG. 4, in some embodiments, the limit structure 320 may be configured as a groove 320a located on a peripheral surface of the linkage wheel 300. Accordingly, the ejecting-abutting portion 611 of the suspension member 610 may be configured to be a shape which matches with a groove shape of the groove 320a and ensure that the ejecting-abutting portion 611 can be snapped and embedded into the groove 320a and disengaged from the groove 320a, to facilitate a smooth clamping for braking of the ejecting-abutting portion 611 and a disengaging and releasing from braking of the ejecting-abutting portion 611.

It is worth noting that a notch of the groove 320a may be provided with a jointing surface for smoothly jointing to a peripheral surface of the linkage wheel 300, to facilitate the ejecting-abutting portion 611 to slide smoothly into the groove 320a relative to the peripheral surface of the linkage wheel 300 and be smoothly disengaged from the groove 320a, and thus the braking and a releasing from braking can be both achieved smoothly and stably.

In some embodiments, a groove shape of the groove 320a may be configured to be C-shaped or V-shaped, and accordingly, the ejecting-abutting portion 611 may also be configured to be an embeddable arc-shaped or spire-shaped structure.

In order to facilitate the ejecting-abutting portion 611 to be smoothly disengaged from the groove 320a, a certain gap may be left between the ejecting-abutting portion 611 and the groove 320a, that is, when the ejecting-abutting portion 611 is snapped and embedded in the groove 320a, a portion of the ejecting-abutting portion 611 is ejected and abutted against an inner wall of the groove 320a, and a gap is formed between another portion of the ejecting-abutting portion 611 and a groove wall of the groove 320a. Therefore, under a premise of ensuring a clamping of the ejecting-abutting portion 611 and the groove 320a, the ejecting-abutting portion 611 can also be smoothly disengaged when subjected to a force slightly greater than the pushing and ejecting force.

FIG. 7 is a schematic diagram showing a cooperation of the suspension member and the suspension limit slide slot of the door opening and closing device in FIG. 3. As shown in FIGS. 3 and 7, in some embodiments, it is considered that a stability of the pushing and ejecting force and a stability of acting effect of the pushing and ejecting force have a positive effect on a braking performance of the ejecting-abutting portion 611. A push-ejection limit slot 612 may be opened on the suspension member 610, and the push-ejection member 620 may be disposed in the push-ejection limit slot 612, to maintain a relatively stable connection state between the push-ejection member 620 and the suspension member 610, and thus an amplitude of relative swing between the push-ejection member 620 and the suspension member 610 can be reduced to a certain extent, to maintain stabilities of a direction of subjected force, a movement direction of the ejecting-abutting portion 611, and a contact area between the ejecting-abutting portion 611 and the limit structure 320, to ensure a braking effect. In some embodiments, the push-ejection member 620 may also be directly connected to the ejecting-abutting portion 611 to concentrate an action point of the pushing and ejecting force on the ejecting-abutting portion 611, to reduce a risk of directional deviation of the pushing and ejecting force and an unstable ejecting-abutting effect due to changes in postures of the suspension member 610 itself.

It is worth noting that specifications of sizes of the push-ejection limit slot 612 and the push-ejection member 620 may be designed to match with one another. The width of the push-ejection limit slot 612 may be slightly larger than a width of the push-ejection member 620, to reduce a space for relative swing to maintain a stability of direction of the pushing and ejecting force.

In some embodiments, a push-ejection limit slot 612 may be configured as a blind hole along a direction of the pushing and ejecting force and capable of accommodating the push-ejection member 620. A bottom of the push-ejection limit slot 612 is disposed on the ejecting-abutting portion 611 to form a limit along a peripheral direction for the push-ejection member 620, to limit a swing amplitude in the peripheral direction, reduce a risk of the suspension member 610 bouncing up under force, and ensure a stability of position and posture of ejection.

In some embodiments, an ejecting-abutting portion 611 is disposed at an end of the suspension member 610 for contacting, ejecting and abutting against the limit structure 320. A connecting portion may also be disposed at another end of the suspension member 610 for connecting the push-ejection member 620. Thus, a molding and processing of the suspension member 610 can be facilitated and a flow of processing can be simplified.

In some embodiments, the push-ejection member 620 may be configured as an elastic member 620a, and thus a continuous and successive pushing and ejecting force is applied through an elastic deformation of the elastic member 620a, to ensure that the suspension member 610 responds to position changes of rotation of the linkage wheel 300 with a simple structure and high time efficiency, and can be quickly ejected and abutted into the limit structure 320 when the limit structure 320 is in place. At the same time, a stability of the elastic deformation of the elastic member 620a enables the pushing and ejecting force applied to the suspension member 610 to maintain a stable state. On the one hand, a stability of a suspended state can be maintained, and on the other hand, the linkage wheel 300 can also be enabled to rotate to release a braking state under an action of a relatively stable and controllable driving force, to achieve a stability, a reliability of a suspension function and a performance for smooth implementation of the suspension function of the door opening and closing device 11.

It is considered that a deformation of the elastic member 620a can be divided into a compressed deformation and a stretched deformation. The elastic member 620a should be assembled in a way which can maintain a relatively stable and linear deformation state of the elastic member 620a.

When the elastic member 620a in a compressed state provides an elastic pushing and ejecting force, the suspension member 610 may be disposed between the elastic member 620a and a peripheral surface of the linkage wheel 300. The elastic member 620a is compressed and disposed between the base 900 and the suspension member 610, and a reset direction of deformation of the elastic member 620a is kept consistent with a direction of the pushing and ejecting force, to convert an elastic pushing force of the elastic member 620a into a stable elastic pushing and ejecting force to output.

When the elastic member 620a in a stretched state provides an elastic pushing and ejecting force, the elastic member 620a can be stretched and disposed between the base 900 and the suspension member 610, and the reset direction of deformation of the elastic member 620a is kept consistent with a direction of the pushing and ejecting force, to convert an elastic pulling force of the elastic member 620a into a stable elastic pushing and ejecting force to output.

In some embodiments, the elastic member 620a is a spring and may be configured as a compression spring or a tension spring, to provide a stable pushing and ejecting force through a compressed deformation or a stretched deformation. The compression spring may be compressed between the suspension member and the base, or the tension spring may be stretched and connected between the suspension member 610 and the base 900.

FIG. 6 shows a schematic structural diagram of a suspension limit slide slot of the door opening and closing device in FIG. 3. As shown in FIG. 6 and FIG. 7, a first end of the compression spring can be ejected and abutted against the ejecting-abutting portion 611. A boss portion 909 with a height substantially equal to that of the compression spring is disposed on the base 900. A second end of the compression spring can be ejected and abutted against the boss portion 909 to keep the compression spring in a straight posture in an axial direction thereof, to form a stable and reliable pushing and ejecting force.

The first end of the tension spring may be fixed on a body of the push-ejection member 620, or directly fixed on the ejecting-abutting portion 611, and the second end of the tension spring may be fixed on the boss portion 909 that is disposed on the base 900. The tension spring should be kept flush with a plate surface of the base 900 and in a straight posture as much as possible to form a stable and reliable push-out force.

In some embodiments, a support socket 908 may be further disposed below the boss portion 909 to limit and support the above springs, to ensure a stability of ejecting and abutting position of the springs and avoid shaking.

In some embodiments, the elastic member 620a may also be an elastic member such as a torsion spring, a leaf spring, etc., as long as a direction of elastic force of the elastic member 620a is roughly consistent with a moving direction of the suspension member 610, which will not be repeated here.

In some embodiments, in order to maintain a stability of moving direction of the suspension member 610 and limit an excessive swing and vibration of the suspension member 610, a suspension limit slide slot 906 may be disposed on the base 900, and the suspension member 610 may be disposed in the suspension limit slide slot 906. The stability of the moving direction of the suspension member 610 is maintained by a guiding and restraining effect of side walls of the suspension limit slide slot 906, to ensure a reliability of braking performance.

As shown in FIG. 6, in some embodiments, the suspension limit slide slot 906 may be configured as two opposite limit bosses 907. The limit bosses 907 may have a certain length in the moving direction of the suspension member 610, as long as the length can ensure that a limit for the suspension member 610 within a sliding stroke can be achieved. An upper limit structure may also be connected to a top of the two limit bosses 907 to limit the suspension member 610 from disengaging from the base 900 to a certain extent. A corresponding upper limit structure may also be disposed and covered on the base 900. The upper limit structure is opposite to the suspension limit slide slot 906 to achieve a purpose of upper limit. Thus, the suspension member 610 can always move in a stable direction to ensure a reliability of braking performance.

In some embodiments, in order to maintain the stability of the moving direction of the suspension member 610 and limit an unstable swinging of the suspension member 610, the suspension member 610 may be configured as rod-shaped, and the ejecting-abutting portion 611 is disposed at an end of the suspension member 610 which is close to the linkage wheel 300, that is, the suspension member 610 may be configured as a structural member with long strip shape having a certain length to cooperate with the suspension limit slide slot 906 to implement a stable sliding. A length characteristic of the long strip structural member and a radial limit effect of the suspension limit groove 906 on the long strip structural member can be utilized to reduce a swing amplitude to a certain extent. Generally speaking, the longer a length in a direction of the pushing and ejecting force of the suspension limit slide slot 906 and a length of the rod-shaped suspension member 610 are, the better a performance of limiting the swing amplitude is, and the more stable the moving direction of the suspension member 610 is.

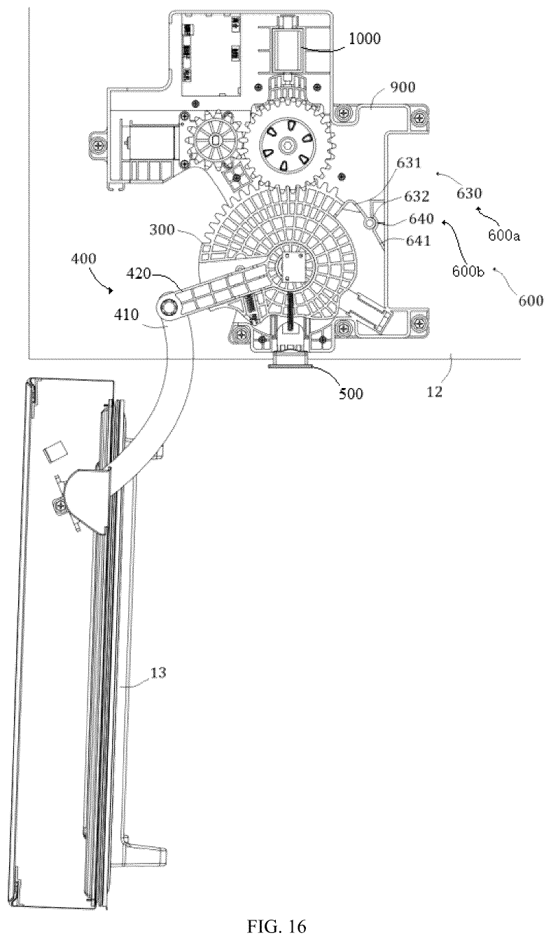

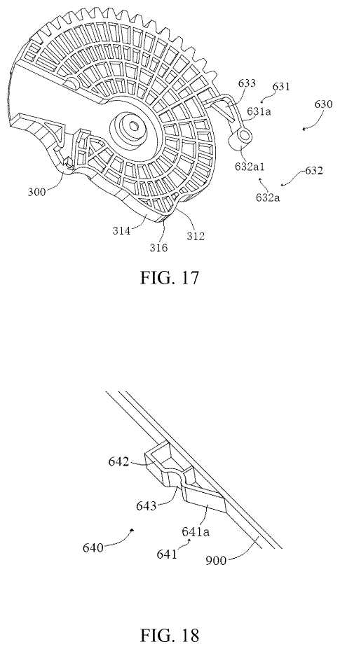

FIG. 16 is a schematic assembly structural diagram of another door opening and closing device of the refrigerator according to some embodiments of the disclosure; FIG. 17 is a schematic structural diagram of a linkage wheel and a suspension mechanism of the door opening and closing device in FIG. 16; FIG. 18 is a schematic structural diagram of a limit mechanism of the door opening and closing device in FIG. 16. As shown in FIGS. 16, 17 and 18, in some embodiments, in order to solve a problem that the door body 13 cannot maintain an opening when the door opening and closing device is shut down, another suspension device 600 may be used. The first engaging portion 600a may include a suspension mechanism 630 disposed on the linkage wheel 300. The second engaging portion 600b includes a limit mechanism 640 disposed on the base 900. In a condition that the linkage wheel 300 rotates, the suspension mechanism 630 rotates with the linkage wheel 300, and thus when the linkage wheel 300 rotates to a preset door opening position, the suspension mechanism 630 may engage with the limit mechanism 640, to lock the linkage wheel 300 on the base 900, and thus the door rotation mechanism 400 is prevented from rotating the door body 13, to achieve a suspension of the door body 13 and maintain the door body 13 in current preset opening state.

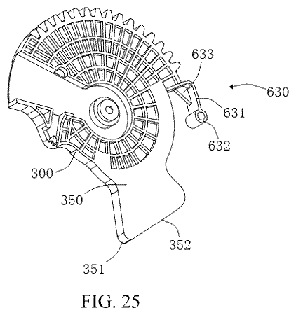

FIG. 25 is a schematic structural diagram of a linkage wheel and a suspension mechanism of the door opening and closing device in FIG. 22. As shown in FIG. 16, FIG. 17, and FIG. 18 and FIG. 25, in some embodiments, the suspension mechanism 630 may include a connecting portion 631 and a suspension portion 632. The suspension portion 632 is connected to the linkage wheel 300 through the connecting portion 631, and thus the suspension portion 632 can rotate with the linkage wheel 300.

The suspension portion 632 serves as a functional portion that engages with the limit mechanism 640, and has a shape which can match with that of the limit mechanism 640, and thus the suspension portion 632 and the limit mechanism 640, in a condition that they are in corresponding positions, can be smoothly engaged and form a certain degree of resistance force for disengagement, that is, a braking force for the linkage wheel 300, to lock the linkage wheel 300 on the base 900.

It is worth mentioning that an engagement state between the suspension portion 632 and the limit mechanism 640 is a reversible state. When an external driving force applied to the linkage wheel 300 is greater than the braking force between the suspension portion 632 and the limit mechanism 640, the linkage wheel 300 transmits the external driving force to the connecting portion 631 to force the suspension portion 632 to be disengaged from the limit mechanism 640, and the linkage wheel 300 continues to rotate. The linkage wheel 300 is released from a braking state, and can drive the door rotation mechanism 400 to rotate the door body 13 to be closed, or can further expand an opening of the door body 13.

In some embodiments, the limit mechanism 640 may be configured as a limit portion 642 located on the base 900, for contacting and limiting the suspension portion 632 to form a certain resistance for movement, to brake the linkage wheel 300. In other embodiments, a limit groove 643 may be opened on the limit portion 642. The suspension portion 632, when rotating to a position where the limit groove 643 is located, can be naturally engaged in the limit groove 643, to limit a disengagement of suspension portion 632 and form a braking force by accommodating or partially accommodating the suspension portion 632.

In some embodiments, in order to form a stable braking force for the linkage wheel 300, the suspension portion 632 may be configured as an independent snapping-embedding member 632a. A shape of the snapping-embedding member 632a is configured to match with a groove shape of the limit groove 643. When the snapping-embedding member 632a rotates to the position where the limit groove 643 is located, a larger engagement contact surface can be formed. Thus, a friction resistance to disengagement can be improved to a certain extent, to form a relatively stable braking force, to be convenient for matching the driving force of the linkage wheel 300 well. Thus, a smooth and stable control mode of driving and braking of the linkage wheel 300 is formed. A stability and reliability of operating of the door opening and closing device is ensured.

In some embodiments, the snapping-embedding member 632a may be configured as an elastically deformable member. When the snapping-embedding member 632a is engaged in a groove body of the limit groove 643, a certain elastic contact pressure is formed to enhance the braking force. Especially when the snapping-embedding member 632a is disengaged from the limit groove 643, a further deformation of the snapping-embedding member 632a is required for the snapping-embedding member 632a to be able to be disengaged from a notch, and thus a stable and reliable braking force is formed.

It is worth mentioning that since the snapping-embedding member 632a rotates with the linkage wheel 300, a moving trajectory of the snapping-embedding member 632a is arc-shaped. The limit groove 643 may be disposed on arc-shaped trajectory of the snapping-embedding member 632a, and the notch of the limit groove 643 is towards a direction of the center of the linkage wheel 300. When the snapping-embedding member 632a rotates to the position where the limit groove 643 is located, a certain deformation of the snapping-embedding member 632a is required before the snapping-embedding member 632a can be snapped and embedded into the limit groove 643. Correspondingly, a certain deformation of the snapping-embedding member 632a is required before the snapping-embedding member 632a can be disengaged from the limit groove 643, and thus a stable braking force is formed.

In some embodiments, a snapping-embedding head 632a1, which is elastically deformable, may be disposed at an end of head of the snapping-embedding member 632a. The snapping-embedding head 632a1 may be deformed to be embedded into or disengaged from the limit groove 643.

In some embodiments, the limit groove 643 is configured as a hollow cylindrical member. A groove shape of the limit groove 643 may also be configured as a shape that fits to a cylindrical peripheral surface of the hollow cylindrical member, and thus a deformation direction of the hollow cylindrical member is mainly a radial direction of the hollow cylindrical member. A deformation area is a peripheral area in a length direction of the hollow cylindrical member. Thus, a regionalized stable deformation can be achieved, and a stable braking force can be ensured.

In some embodiments, the hollow cylindrical member may be a rubber member or members made of other materials that have a stable performance of elastic deformation. An elastic coefficient can be specifically and comprehensively configured as matching with arrangement positions of the limit slot and the suspension member to ensure smooth operations of engagement and releasing engagement, and thus reduce a vibration and swing amplitude.

In some embodiments, the snapping-embedding member 632a may be integrally formed with the connecting portion 631, to facilitate a processing of components and improving assembly efficiency. The connecting portion may be fixed on the linkage wheel 300 through a fixed connection mechanism, or may be integrally formed on the linkage wheel 300.

In other embodiments, the snapping-embedding member 632a may also be connected to the connecting portion 631 through a fixed connection structure, to achieve an easily disassembling, assembling and replacement. Accordingly, the connecting portion 631 may be integrally formed with the linkage wheel 300 to facilitate an overall assembly. The connecting portion 631 may also be fixed to the linkage wheel 300 through a fixed connection structure to enrich connection way and facilitate maintenance and replacement.

In some embodiments, in order to achieve a smooth suspension operation, the second engaging portion 600b may further include a guide portion 641 that is connected to a side of the limit portion 642. During the linkage wheel 300 rotates, the suspension portion 632 may contact and move along the guide portion 641. The guide portion 641 can play a role of buffering and guiding to guide the suspension portion 632 to smoothly engage into the limit groove 643, to avoid the suspension portion 632 from being unable to stably engage in the limit groove 643 due to inertia.

In some embodiments, the guide portion 641 may be configured as a guide plane 641a which is tangent to a peripheral surface of the linkage wheel 300. The limit groove 643 is disposed at an end of the guide plane 641a, and thus the suspension portion 632 contacts and moves along the guide plane 641a, directly falls to be in position, and snapped and embedded into the limit groove 643.

It is worth mentioning that a tangent point of the guide plane 641a with the arc-shaped trajectory of the suspension portion 632 may be disposed at a notch of the limit groove 643. When the suspension portion 632 just contacts the guide plane, the suspension portion 632 after forming a certain contact pressure is immediately engaged into the limit groove 643. When the linkage wheel 300 is to be released from the braking state, it is required to break through this contact pressure to form a stable ejecting and pushing force, to facilitate the driver of the linkage wheel 300 to implement a stable controlling operation of driving.

In some embodiments, the connecting portion 631 may also be configured as a connecting arm 631a which is elastically deformable, and thus the suspension portion 632 can be smoothly and stably engaged into the limit groove 643 through an elastic deformation of the connecting arm 631a. The suspension portion 632 can be disengaged from the limit groove 643 under an action of a stable compelling force. Thus, smooth operations of braking and releasing braking can be achieved.

In order to ensure a reliability of the suspension mechanism 630, a length of the connecting arm 631a should not be too large to avoid an excessive deformation. The excessive deformation affects a state of subjected force of the suspension portion 632, resulting in that the suspension portion 632 is unable to be stably engaged in the limit groove 643, or is easily disengaged from the limit groove 643, and thus a braking effect is deteriorated.

In some embodiments, a reinforcing rib plate 633 may be further disposed between the connecting arm 631a and the linkage wheel 300 to reinforce a connection relationship and limit an excessive deformation of the connecting arm 631a to a certain extent.

In some embodiments, the connecting portion 631 may be made of a composite material and configured as a structure with gradually changed hardness and elasticity, to take into account a stable elastic deformation, a reliable structural strength and stability of form together, to ensure a stability of the subjected force and a braking effect of the suspension portion 632.

In some embodiments, the door opening and closing device is also provided with a door ejection mechanism for breaking through an adsorption force such as a negative pressure adsorption force and the like between the door body 13 and the box body 12. The door ejection mechanism is disposed on the linkage wheel 300. As the linkage wheel 300 rotates to eject and push the door body 13 and after the adsorption force is broken through, the door rotation mechanism 400 continues to rotate the door body 13, to implement a relay of door opening operation.

The door rotation mechanism 400, the door ejection mechanism and the suspension mechanism 630 are all directly connected to the linkage wheel 300. In order to reduce interferences among the above various structures, the door rotation mechanism 400 and the suspension mechanism 630 may be respectively disposed at two opposite sides of the door ejection mechanism. Thus, after the door ejection mechanism first ejects and opens the door body, the door rotation mechanism 400 and the suspension mechanism 630 can independently implement operations of door rotation and suspension braking at opposite two positions which are spaced apart with a certain distance and without interfering with each other, to achieve harmonious compatibility in space and ensure smoothness and stability of operation.

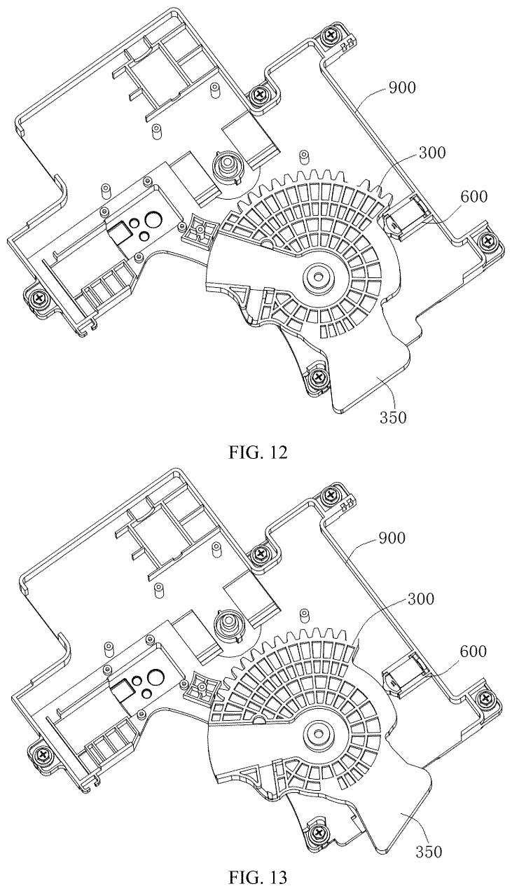

FIG. 12 is a schematic assembly structural diagram of another door ejection mechanism of the door opening and closing device in FIG. 3; and FIG. 22 is a schematic diagram showing an initial state of a door ejection mechanism of yet another door opening and closing device according to some embodiments of the disclosure. As shown in FIG. 1, FIG. 12 and FIG. 22, in some embodiments, the door opening and closing device is also provided with a door ejection portion 350 for breaking through an adsorption force such as negative pressure adsorption force and the like between the door body 13 and the box body 12. The door ejection portion 350 is disposed on the linkage wheel 300 to rotate with the rotation of the linkage wheel 300 to push the door body 13 to break through an adsorption force, and then the door rotation mechanism 400 continues to rotate the door body 13 to implement a relay of door opening operation.

That is, two implementations of the mechanisms for door ejection, and two implementations of the suspension device 600 are provided according to some embodiments of the disclosure. Thus, ways of combination of the suspension device 600 and the door ejection mechanisms 500 can be divided into four types. The above description has been made with respect to implementations of the suspension device 600. The following description will be made with respect to two types of door ejection mechanism 500 respectively.

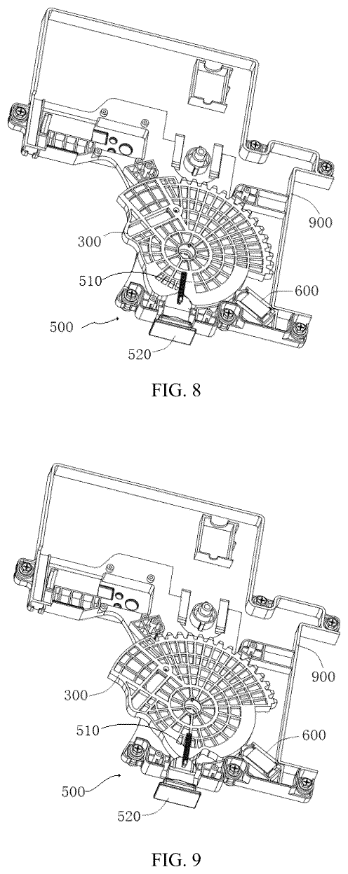

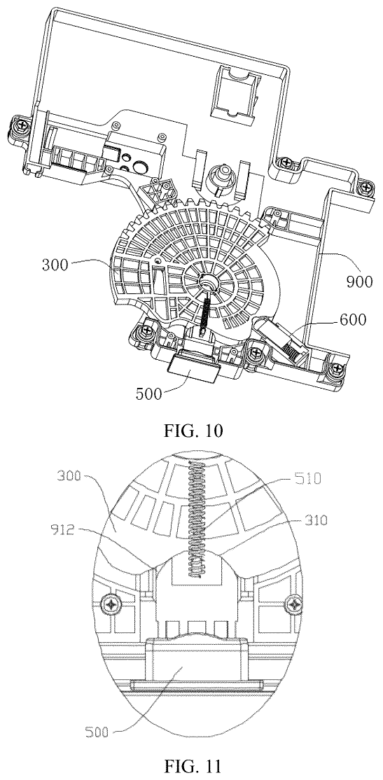

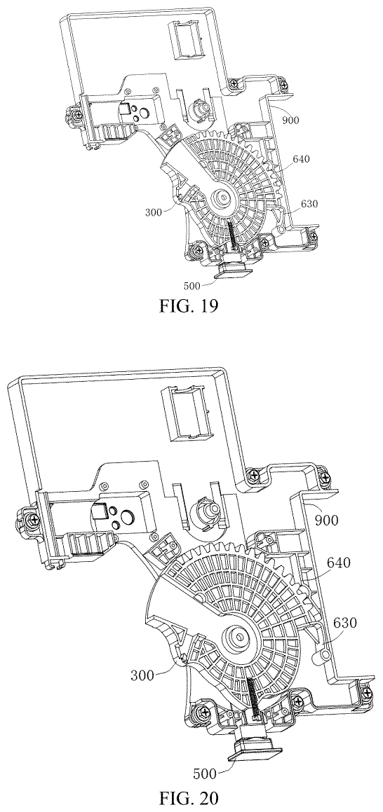

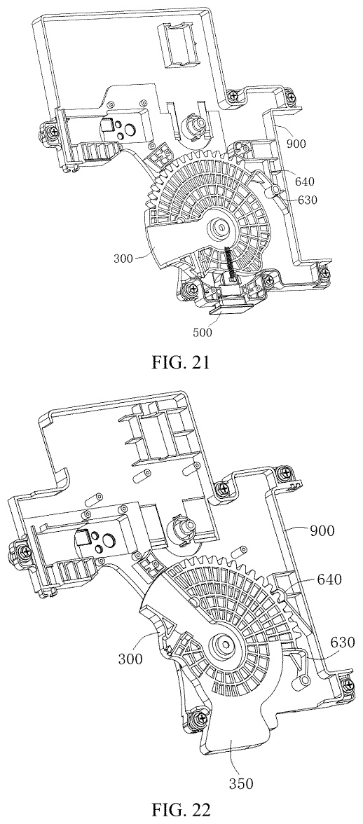

FIG. 8 is a schematic diagram showing an initial state of a door ejection mechanism of the door opening and closing device in FIG. 3; FIG. 9 is a schematic diagram showing a door ejection state of the door ejection mechanism of the door opening and closing device in FIG. 3; FIG. 10 is a schematic diagram showing an initial state of the door ejection mechanism of the door opening and closing device in FIG. 3; FIG. 11 shows a schematic structural diagram of the door ejection mechanism of the door opening and closing device in FIG. 3; FIG. 19 is a schematic structural diagram showing an initial state of a door opening and closing device in FIG. 18; FIG. 20 is a schematic structural diagram showing a door ejection state of the suspension mechanism of the door opening and closing device in FIG. 19; FIG. 21 is a schematic structural diagram showing a suspended state of the door opening and closing device in FIG. 19. As shown in FIG. 8, FIG. 9, FIG. 10, FIG. 11, FIG. 17, FIG. 19, FIG. 20 and FIG. 21, in some embodiments, the door ejection mechanism 500 may include a door ejection member 520. The door ejection member 520 may be movably disposed on the base 900. The linkage wheel 300 is opened with an abutting-holding portion 310. In a condition that the driver 1000 drives the linkage wheel 300 to rotate, the abutting-holding portion 310 can rotate with the linkage wheel 300, and push the door ejection member 520 to move relative to the base 900 to make the door ejection member 520 eject the door body 13 open.

In some embodiments of the disclosure, in order to improve a sealing effect between the door body 13 and the box body 12 when the door body 13 is closed on the box body 12, the door body 13 is usually pressed onto the box body 12 with a relatively large pressure, or the door body 13 is adsorbed onto the box body 12 through an adsorption structure. There is a larger adsorption force between the door body 13 and the box body 12, and thus a larger force is required for the door body 13 to be disengaged from the box body 12 when the door body 13 needs to be opened. An abutting-holding portion 310 is disposed on the linkage wheel 300. In a condition that the linkage wheel 300 rotates, the abutting-holding portion 310 can push the door ejection member to move relative to the box body 12, to eject the door body 13 open. The abutting-holding portion 310 disposed on the linkage wheel 300 directly acts on the door ejection member to directly eject the door body 13 open. That is, the linkage wheel 300 can be driven by a driving structure to rotate, to make the door ejection member eject the door body 13 open. Thus, the number of components of entire door opening and closing device can be reduced, and an integration of entire door opening and closing device can be improved.

In some embodiments, in a condition that the linkage wheel 300 rotates, the door ejection member cannot rotate with the linkage wheel 300, and the door ejection member 520 can move toward or away from the door body 13 under an action of the abutting-holding portion 310, to eject the door body 13 open. The door ejection member 520 can be attached to an outer surface of the abutting-holding portion 310. During the linkage wheel 300 rotates, the door ejection member 520 moves along a profile of the outer surface of the abutting-holding portion 310 and moves in a direction approaching to or away from the door body 13 to eject the door body 13 open.

That is to say, in some embodiments of the disclosure, there is no direct connection relationship between the door ejection member 520 and the abutting-holding portion 310. The door ejection member 520 may be in contact with the abutting-holding portion 310, or may not be in contact with the abutting-holding portion 310. When a driving structure drives the linkage wheel 300 to rotate, the door ejection member 520 may be abutted against and held by the abutting-holding portion 310, and may be pushed by the abutting-holding portion 310 to move in a direction approaching to the door body 13 to eject the door body 13 open.

In other words, in some embodiments of the disclosure, the abutting-holding portion 310 rotates with the linkage wheel 300, while the door ejection member 520 performs a linear motion.

For the convenience of description, a rotation direction of the linkage wheel 300 that can open the door body 13 is defined as rotating forward. If the door opening and closing device receives a door opening signal, a driving structure drives the linkage wheel 300 to rotate forward, and the door rotation mechanism 400 can follow the linkage wheel 300 to rotate forward, to open the door body 13. If the door opening and closing device receives a door closing signal, the driving structure drives the linkage wheel 300 to reverse, and the door rotation mechanism 400 can reverse with the linkage wheel 300, to close the door body 13.

As shown in FIG. 17, in some embodiments, the abutting-holding portion 310 has a door ejection surface 312. In a condition that the abutting-holding portion 310 rotates with the linkage wheel 300, the door ejection surface 312 abuts against and holds the door ejection member 520, and can push the door ejection member 520 to move relative to the base 900, to make the door ejection member 520 eject the door body 13 open.

The door ejection surface 312 may be disposed at a side of the abutting-holding portion 310. During the abutting-holding portion 310 rotates with the linkage wheel 300, the door ejection surface 312 abuts against and holds the door ejection member, to make the door ejection member 520 move in a direction approaching to the door body 13, and the door ejection member 520 gradually extends out of the box body 12. As the linkage wheel 300 rotates, the door ejection member 520 extends more and more out of the box body 12, to gradually eject the door body 13 open.

In some embodiments, the abutting-holding portion 310 is disposed on and protruded from the linkage wheel 300, and thus distances from a rotation center of the linkage wheel 300 to various locations on the door ejection surface 312 are different. Since the distances from the rotation center of the linkage wheel 300 to various locations on the door ejection surface 312 are different, during a rotation of the linkage wheel 300, the door ejection surface 312 abuts against and holds the door ejection member 520 to move in a direction approaching to the door body 13, to make the door ejection member 520 gradually eject the door body 13 open.

In some embodiments, the door ejection surface 312 gradually extends in a direction away from the rotation center of the linkage wheel 300. It can be understood that the door ejection surface 312 is inclined, and when the door body 13 is closed on the box body 12, the door ejection member 520 is disposed at a connection position between the door ejection surface 312 and the linkage wheel 300. Since the door ejection surface 312 is protruded and inclined in a direction away from the rotation center of the linkage wheel 300, when the linkage wheel 300 is driven by a driving structure to rotate, the door ejection surface 312 will abut against and hold the door ejection member to move in a direction approaching to the door body 13, to make the door ejection member 520 gradually extend out of the box body 12, to eject the door body 13 open.

It is easy to understand that an angle by which the door member 520 can open the door body 13 is related to a distance between the door ejection surface 312 and the rotation center of the linkage wheel 300. For the convenience of description, a point on the door ejection surface 312 which is farthest from the rotation center of the linkage wheel 300 is defined as the connection point 316. If the distance between the connection point 316 and the rotation center of the linkage wheel 300 is farther, an extending length of the door ejection member is longer, and the angle by which the door body 13 to be opened is larger.

In some embodiments, the door ejection member 520 can eject the door body 13 open by an angle of 3 degrees to 5 degrees. The angle can be flexibly set according to an angle required to break through a door-opening resistance force of the door body 13.

In some embodiments, during a process in which the door body 13 is ejected open through the door ejection surface 312, the door body 13 may have been ejected open through a middle portion of the door ejection surface 312, and thus the door body 13 can be opened by a smaller angle to facilitate the door rotation mechanism 400 to continue opening the door body 13 during a continuous rotation of the linkage wheel 300.

In some embodiments, the abutting-holding portion 310 further includes an avoidance surface 314, which is connected to the door ejection surface 312. After the door ejection member 520 is disengaged from abutting and holding with the door ejection surface 312, the elastic reset member 510 can be reset and can follow a movement of the avoidance surface 314.

In a direction of forward rotation of the linkage wheel 300, the door ejection surface 312 is disposed in front of the avoidance surface 314, that is, in a process of rotation of the linkage wheel 300, the door ejection surface 312 first contacts the door ejection member, to eject and abut against the door ejection member 520 to move in a direction approaching to the door body 13. After the door ejection member 520 is disengaged from ejecting and abutting with the door ejection surface 312, the door ejection member 520 contacts the avoidance surface 314, to enable the door ejection member 520 to move in a direction away from the door body 13. Thus, the door ejection member 520 after ejecting the door body 13 open, can be retracted onto the box body 12 to facilitate subsequent closing of the door.

It is easy to understand that if the linkage wheel 300 is not provided with the avoidance surface 314 thereon, after the door ejection member 520 ejects the door body 13 open, the door ejection member 520 always extends out of the door body 13. When the door body 13 needs to be closed, the door ejection member 520 is located outside the box body 12 and will interfere with the door body 13, and the door body 13 cannot be closed. Therefore, a main purpose of providing the avoidance surface 314 is to provide the door ejection member 520 with a space to be retracted to the box body 12 after the door ejection member 520 ejects the door body 13 open. Thus, the door ejection member 520 can be retracted onto the box body 12 after the door ejection member 520 ejects the door body 13 open, to avoid the door body 13 being unable to be retracted.

In some embodiments, after the door ejection surface 312 ejects and abuts against the door ejection member to an outside of the box body 12 and when the avoidance surface 314 rotates to a rear of the door ejection member 520, the door ejection member 520 cannot automatically return to an original position and cannot automatically follow the avoidance surface 314 to be retracted onto the box body 12. An elastic reset member 510 may be disposed on the base 900 and the door ejection member 520. The door ejection member 520 can be retracted onto the box body 12 through a restoring force of the elastic reset member 510.

That is, in a process of the door ejection surface 312 ejecting and abutting against the door ejection member 520, the elastic reset member 510 is gradually deformed. When the connection point 316 contacts the door ejection member 520, a deformation of the elastic reset member 510 reaches the maximum. In a process of the driving structure driving the linkage wheel 300 to continue to rotate, the door ejection member 520 is disengaged from abutting and holding with the door ejection surface 312. After the disengagement, the avoidance surface 314 provides a space for the door ejection member to be retracted onto the box body 12. The door ejection member 520, under an action of the restoring force of the elastic reset member 510, moves in the direction away from the door body 13, to enable the entire door ejection member 520 to be retracted onto the box body 12, to facilitate a closing of the door body 13.

In some embodiments, the elastic reset member 510 may be a spring or a torsion spring, either one of which may be selected.

In a condition that the elastic reset member 510 is a spring, an end of the spring is connected to the door ejection member 520, and another end of the spring may be fixed on the base 900 or may be fixed on a connecting shaft of the linkage wheel 300. In some embodiments, the rotating shaft is fixedly connected to the base 900. That is to say, an end of the spring away from the door ejection member is required to be connected to a fixed structure.

If the elastic reset member 510 is a spring, the spring is gradually stretched during the process of the door ejection surface 312 ejecting and abutting against the door ejection member. The spring reaches a maximum stretched amount when the connection point 316 contacts the door ejection member 520. In a process of the driving structure driving the linkage wheel 300 to continue to rotate, the door ejection member 520 is disengaged from abutting and holding with the door ejection surface 312. After the disengagement, the avoidance surface 314 provides a space for the door ejection member 520 to be retracted onto the box body 12. The door ejection member 520, under an action of the restoring force of the spring, moves in the direction away from the door body 13, to enable the entire door ejection member 520 to be retracted onto the box body 12, to facilitate a closing of the door body 13.

When the elastic reset member 510 is a torsion spring, a middle portion of the torsion spring and a first end of the torsion spring are disposed on the base 900, and a second end of the torsion spring is connected to the door ejection member. In some embodiments, the middle portion of the torsion spring is connected to the first end and the second end respectively. When the door ejection member ejects the door body 13 open, the door ejection member needs to overcome a torsion force of the torsion spring.

If the elastic reset member 510 is a torsion spring and in a condition that the door ejection member 520 is ejected and abutted against by the door ejection surface 312 to move in a direction approaching to the door body 13, the torsion spring is twisted. After the door ejection member 520 is disengaged from abutting and holding with the door ejection surface 312, the door ejection member 520, under the action of the restoring force of the torsion spring, can follow the avoidance surface 314 to move in the direction away from the door body 13, to enable the door ejection member 520 to be reset to avoid an interference of the door ejection member 520 and the door body 13, and to facilitate closing the door.

In some embodiments, the door ejection surface 312 and the avoidance surface 314 are connected at the connection point 316. A distance between the connection point 316 and the rotation center of the linkage wheel 300 is greater than a distance from any point on the avoidance surface 314 and the door ejection surface 312 to the rotation center of the linkage wheel 300.

In some embodiments, the door ejection surface 312 and the avoidance surface 314 are connected to each other. A point where the door ejection surface 312 and the avoidance surface 314 are connected can be defined as the connection point 316. The connection point 316 is a point on the door ejection surface 312 and the avoidance surface 314 that is farthest from the rotation center of the linkage wheel 300. In a condition that the connection point 316 ejects and abuts against the door ejection member 520, the door ejection member 520 ejects the door body 13 to open by a maximum angle. When the avoidance surface 314 rotates to a rear of the door ejection member 520, the avoidance surface 314 provides the door ejection member 520 with a space for moving away from the door body 13, to enable the door ejection member 520 to be retracted onto the box body 12, to be convenient for subsequent closing of the door.

It is easy to understand that, in a process of the door ejection surface 312 ejecting and abutting against the door ejection member 520, the door body 13 is gradually opened. It is not that the door body 13 is opened by the door ejection member 520 only at a time when the connection point 316 is in contact with the door ejection member 520. In a process of the door ejection surface 312 rotating with the linkage wheel 300, it is possible that when one of points on the door ejection surface 312 ejects and abuts against the door ejection member 520, the door ejection member 520 ejects the door body 13 open. It is only when the connection point 316 ejects and abuts against the door ejection member 520, the door body 13 in a door ejection stage reaches the maximum opening.

A speed of ejecting door of the door ejection member 520 is related to a rotation speed of the linkage wheel 300 which is driven by the driving structure. The faster the linkage wheel 300 rotates, the faster the door ejection member 520 ejects the door body 13 open. If the rotation speed of the linkage wheel 300 is slower, the speed at which the door ejection member 520 ejects the door body 13 open will be slower.

In some embodiments, the avoidance surface 314 and the door ejection surface 312 may be cambered surfaces or inclined planes.

It should be noted that, in some embodiments, an end of the door rotation mechanism 400 is connected to the linkage wheel 300, and another end of the door rotation mechanism 400 is connected to the door body 13. The door ejection member 520 and the door rotation mechanism 400 can be driven by a same driving structure and linkage wheel 300 to realize functions of ejecting the door and opening the door. The door ejection member first ejects the door body 13 open by a smaller angle, and the door rotation mechanism 400 then further opens the door body 13.

During a rotation of the linkage wheel 300, the suspension mechanism 630 is engaged into the limit mechanism 640, to enable the linkage wheel 300 to stop rotating. Thus, the door rotation mechanism 400 cannot further open the door body 13, and the door body 13 can stop rotating relative to the box body 12.

As shown in FIG. 11, in this embodiment, a mounting groove 912 is disposed on the base 900. The door ejection member 520 is movably disposed in the mounting groove 912. The mounting groove 912 is in a shape of an elongated strip. Since the door ejection member 520 is disposed in the mounting groove 912, the door ejection member 520 can move along an extending direction of the mounting groove 912, to enable the door ejection member to move closer to or away from the door body 13.

In some embodiments, the extending direction of the mounting groove 912 may be from the linkage wheel 300 to the door body 13. In order to reduce a loss of a door ejection force when the door ejection member is ejecting the door, the mounting groove 912 may be perpendicular to the door body 13 when the door body 13 is closed.

In some embodiments, the abutting-holding portion 310 and the linkage wheel 300 are integrally formed. The abutting-holding portion 310 and the linkage wheel 300 are integrally formed, it is equivalent to the linkage wheel 300 directly interacting with the door ejection member, to be capable of reducing the number of other components and reducing structures of the door opening and closing device 11 to decrease an occupied space.

In some embodiments, the linkage wheel 300 is driven by the driving structure to rotate. The rotation of the linkage wheel 300 can be converted into a movement of the door ejection member 520 by providing the abutting-holding portion 310. The door can be ejected by providing the linkage wheel 300 before the door is opened, and thus an application range of the linkage wheel 300 is increased, a driving structure for the door ejection member 520 is reduced. Thus, structures of the door opening and closing device 11 are decreased and the occupied space is reduced.

In conclusion, the door opening and closing device 11 is provided according to some embodiments of the disclosure. In order to improve a sealing effect between the door body 13 and the box body 12 when the door body 13 is closed on the box body 12, the door body 13 is usually pressed onto the box body 12 with a relatively large pressure, or the door body 13 is adsorbed onto the box body 12 through an adsorption structure. There is a larger adsorption force between the door body 13 and the box body 12, and thus a larger force is required for the door body 13 to be disengaged from the box body 12 when the door body 13 is opened. An abutting-holding portion 310 is disposed on the linkage wheel 300. In a condition that the linkage wheel 300 rotates, the abutting-holding portion 310 can push the door ejection member to move relative to the box body 12, to eject the door body 13 open. The abutting-holding portion 310 disposed on the linkage wheel 300 directly acts on the door ejection member to directly eject the door body 13 open. That is, the linkage wheel 300 can be driven by a driving structure to rotate, to make the door ejection member eject the door body 13 open. Thus, the number of components of entire door opening and closing device can be reduced, and an integration of entire door opening and closing device can be improved.

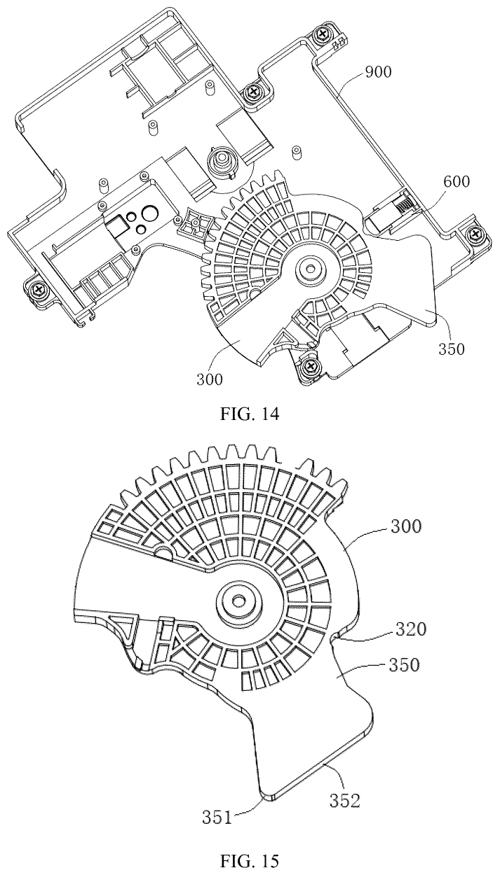

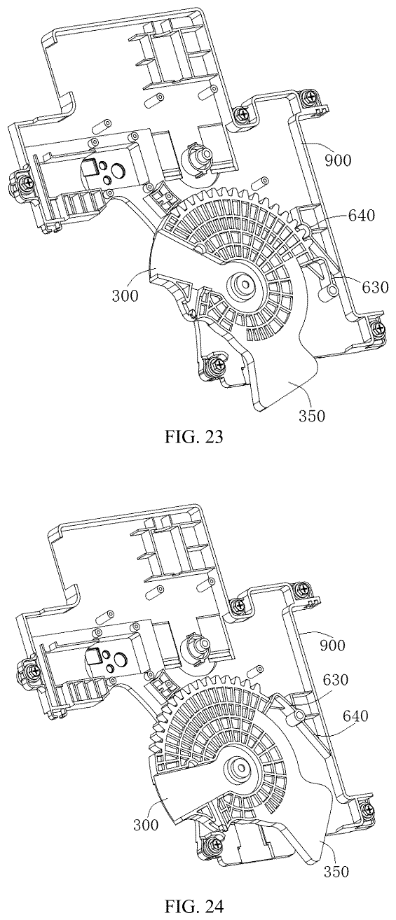

FIG. 13 is a schematic structural diagram showing a door ejection state of the door ejection mechanism of the door opening and closing device in FIG. 12; FIG. 14 is a schematic structural diagram showing a suspended state of the door ejection mechanism of the door opening and closing device in FIG. 12; FIG. 15 shows a schematic structural diagram of a linkage wheel of the door opening and closing device in FIG. 12; FIG. 23 is a schematic diagram showing a door ejection state of the door ejection mechanism of the door opening and closing device in FIG. 22; FIG. 24 is a schematic diagram showing a suspended state of the door ejection mechanism of the door opening and closing device in FIG. 22. As shown in FIG. 12, FIG. 13, FIG. 14, FIG. 15, FIG. 22, FIG. 23, FIG. 24 and FIG. 25, in some embodiments, the door ejection mechanism may also be configured as a door ejection portion 350 which is disposed on and protruded from the linkage wheel 300. In a condition that the linkage wheel 300 rotates, the door ejection portion 350 extends out of the base 900 to directly break through door-opening resistance forces such as an adsorption force of the door body 13 and the like to eject the door body 13 open. Thus, the door rotation mechanism 400 is facilitated to rotate the door body 13, to reduce a difficulty of opening the door to a certain extent.

It is worth explaining that the door ejection portion 350 ejects the door body 13 open means that when the door body 13 encloses the box body 12, that is, in a condition that the door body 13 is adsorbed on the box body 12, the door ejection portion 350 rotates with the linkage wheel 300. During a rotation of the door ejection portion 350, the door ejection portion 350 gradually acts on the door body 13, to cause the door body 13 and the box body 12 to be disengaged from an adsorption, to eject the door body 13 open.

In some embodiments, the door ejection portion 350 has a door ejection point 351. In a condition that the driver 1000 drives the linkage wheel 300 to rotate, the door ejection point 351 abuts against and holds the door body 13 to eject the door body 13 open.

During the driver 1000 drives the linkage wheel 300 to rotate, the door ejection portion 350 gradually contacts the door body 13. In a condition that the driver continues to drive the linkage wheel 300 to rotate, the door ejection portion 350 extends out of the box body 12, to cause the door ejection point 351 to eject the door body 13 open.

In some embodiments, the door ejection point 351 is a point on the door ejection portion 350 that is farthest from a rotation center of the linkage wheel 300. During the driver 1000 drives the linkage wheel 300 to rotate, the door ejection portion 350 rotates with the linkage wheel 300. The door ejection point 351 can eject the door body 13 to a farthest location where the door ejection portion 350 can eject and abut against the door body 13.

In some embodiments, the door ejection portion 350 has an exterior surface 352, and the door ejection point 351 is disposed at an end of the exterior surface 352.

In some embodiments, the exterior surface 352 is a plane. The door ejection point 351 is disposed at an end of the exterior surface 352. During the driver drives the linkage wheel 300 to rotate, a portion of the exterior surface 352 rotates onto the box body 12, and another portion of the exterior surface 352 rotates outside the box body 12. The portion of the exterior surface 352 outside the box body 12 gradually ejects and abuts against the door body 13 until the door ejection point 351 abuts against and holds the door body 13 and eject the door body 13 open.

It is easy to understand that, during the exterior surface 352 rotates with the linkage wheel 300, the portion of the exterior surface 352 extending out of the box body 12 gradually abuts against and holds the door body 13. During a rotation of the exterior surface 352, the portion of the exterior surface 352 extending out of the box body 12 becomes more and more, to increase an abutting-holding force with the door body 13, to enable the door body 13 to overcome the adsorption force between the door body 13 and the box body 12, to eject the door body 13 open.

When the door body 13 is closed, the exterior surface 352 is flush with an opening of the box body 12. During the driver drives the linkage wheel 300 to rotate, the door ejection point 351 can quickly rotate out of the box body 12, to enable the door ejection point 351 to quickly eject the door body 13 open.

In some embodiments, in a condition that the door body 13 is closed, the exterior surface 352 is flush with an opening of the box body 12, to ensure an aesthetic appearance when the door opening and closing device 11 is not activated.

According to the refrigerator provided by some embodiments of the disclosure, a driver drives a linkage wheel to drive a door rotation mechanism to rotate the door body, to implement automatic opening and closing of the door; and the linkage wheel is rotated forward and reversely to drive the door rotation mechanism to push and pull the door body, to implement opening and closing of the door; a suspension device is formed by disposing a first engaging portion on the linkage wheel and a second engaging portion on the box body as a functional structure for braking the linkage wheel. The suspension device tracks a position of rotating periphery surface of the linkage wheel. In a condition that the linkage wheel rotates to a state in which the first engaging portion and the second engaging portion are opposite, the first engaging portion and the second engaging portion are engaged to lock the linkage wheel on the base, to realize a braking of the linkage wheel, to brake the door rotation mechanism connected to the linkage wheel. Thus, a suspension of the door body is realized. A stability of the door body opening is ensured. A difficulty of opening the door is reduced and at the same time use is facilitated. A risk of collision is reduced.

In the disclosure, unless otherwise clearly specified and limited, a first feature being “above” or “under” a second feature may include the first and second features being in direct contact, or may include the first and second features not being in direct contact but being in contact through another feature there between. In one embodiment, a first feature is “above”, “at a top of” and “on” a second feature includes the first feature being directly above and obliquely above the second feature, or simply means that the first feature is at a higher level than the second feature. A first feature being “below,” “beneath,” and “under” a second feature includes the first feature being directly below and obliquely below the second feature, or simply means that the first feature is at a smaller horizontal height than the second feature.

In the description of the disclosure, it should be understood that the terms “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise” and “counterclockwise” indicate orientations or positional relationships based on orientations or positional relationships shown in the accompanying drawings, and are only for the convenience of describing the disclosure and simplifying the description, and do not indicate or imply that the referred device or element must have a specific orientation, be constructed and operated in a specific orientation, and therefore should not be understood as a limitation on the disclosure.

It should be noted that all directional indications in the embodiments of the disclosure are only configured to explain the relative position relationship, movement status and so on among the components in a certain specific posture. If the specific posture changes, the directional indication will also change accordingly.

In the disclosure, unless otherwise clearly stipulated and limited, the terms “connected”, “fixed” and so on should be understood in a broad sense. For example, “fixed” can be a fixed connection, a detachable connection, or an integral connection; it can be a mechanical connection or an electrical connection; it can be a direct connection or an indirect connection through an intermediate medium; it can be an internal connection of two elements or an interaction relationship between two elements, unless otherwise clearly limited. The specific meanings of the above terms in the embodiments of the disclosure can be understood according to specific circumstances.

In addition, descriptions such as “first”, “second” and so on in the disclosure are only used for descriptive purposes and cannot be understood as indicating or implying relative importance thereof or implicitly indicating the number of the indicated features. Therefore, the features defined as “first” or “second” may explicitly or implicitly include one or more features. In the description of the disclosure, “a plurality of” means two or more than two, unless otherwise clearly and specifically defined.

In the description of this specification, the description with reference to the terms “one embodiment”, “some embodiments”, “example”, “specific example”, or “some examples” and so on means that the specific features, structures, materials or characteristics described in conjunction with the embodiment or example are included in at least one embodiment or example of the disclosure. In the specification, the exemplary expressions of the above terms do not necessarily refer to the same embodiment or example. Furthermore, the specific features, structures, materials, or characteristics described may be combined in any suitable manner in any one or more embodiments or examples. Furthermore, combining and coupling different embodiments or examples described in this specification may be done.

In addition, the various embodiments can be combined with one another, but the combined embodiments must be based on that they can be implemented. When the combined embodiments are contradictory or cannot be realized, it should be considered that such combined embodiments do not exist, and are not within the protection scope sought for by the present disclosure.

Although embodiments of the disclosure have been shown and described, it will be appreciated that various changes, modifications, substitutions and alterations may be made to the embodiments without departing from the principles and spirit of the disclosure, the scope of which is defined by the claims and equivalents thereof.

1. A refrigerator, comprising:
a box body formed with an accommodation space which has an opening;
a door body rotatably connected to the box body to enclose or open the opening;
a door rotation mechanism connected to the door body;
a driver disposed on the box body;
a linkage wheel, rotatably disposed on a housing and connected to the driver and the door rotation mechanism, wherein in a condition that the driver is activated, the linkage wheel rotates to drive the door rotation mechanism to drive a rotation of the door body; and
a suspension device, comprising a first engaging portion which is disposed on the linkage wheel and a second engaging portion which is disposed on the box body, wherein the linkage wheel rotates to drive the first engaging portion and the second engaging portion to be opposite and engaged, to prevent the door rotation mechanism from rotating the door body.

2. The refrigerator according to claim 1, wherein the first engaging portion comprises a limit structure formed on the linkage wheel, and wherein the second engaging portion comprises a suspension member and a push-ejection member;
the push-ejection member is disposed on the box body, the suspension member being movably disposed on the box body, wherein the suspension member is connected to the push-ejection member, and ejects and abuts against the linkage wheel;
in a condition that the linkage wheel rotates to a state in which the limit structure is opposite to the second engaging portion, the push-ejection member pushes the suspension member to move to eject and abut into the limit structure.

3. The refrigerator according to claim 2, wherein the suspension member is formed with an ejecting-abutting portion thereon, the ejecting-abutting portion ejecting and abutting against the linkage wheel, the ejecting-abutting portion being connected to the push-ejection member.

4. The refrigerator according to claim 2, wherein the suspension member is formed with a push-ejection limit slot thereon, the push-ejection member being disposed in the push-ejection limit slot.

5. The refrigerator according to claim 2, wherein the suspension member is formed with an ejecting-abutting portion and a connecting portion thereon, the ejecting-abutting portion ejecting and abutting against the linkage wheel, the connecting portion being connected to the push-ejection member.

6. The refrigerator according to claim 3, wherein the push-ejection member is an elastic member an end of which is connected to the box body and another end of which is connected to the suspension member, and wherein the elastic member is elastically compressed or stretched between the box body and the suspension member.

7. The refrigerator according to claim 6, wherein the box body is formed with a suspension limit slide slot thereon, the suspension member being slidably embedded in the suspension limit slide slot, and wherein the elastic member is disposed in the suspension limit slide slot, with an end ejecting and abutting against the box body and another end ejecting and abutting against the suspension member.

8. The refrigerator according to claim 3, wherein the suspension member is rod-shaped and formed with the ejecting-abutting portion on an end thereof.

9. The refrigerator according to claim 6, wherein the elastic member is a spring.

10. The refrigerator according to claim 2, wherein the limit structure comprises a groove which is disposed on a peripheral surface of the linkage wheel, the suspension member ejecting and abutting in the groove to prevent the door rotation mechanism from rotating the door body, wherein a the groove is C-shaped or V-shaped.

11. (canceled)

12. The refrigerator according to claim 1, wherein the first engaging portion comprises: a suspension portion and a connecting portion, the connecting portion connecting the suspension portion and the linkage wheel;
the second engaging portion comprises a limit portion which is disposed on the box body, the limit portion being opened with a limit groove thereon, and wherein, when the suspension portion is engaged with a limit mechanism, the suspension portion is engaged in the limit groove; and
the linkage wheel rotates to drive the suspension portion to be engaged with the limit groove, to prevent the door rotation mechanism from rotating the door body, wherein the second engaging portion further comprises a guide portion which is connected to the limit portion, and wherein, when the linkage wheel rotates, the suspension portion moves along the guide portion to guide the suspension portion to be engaged in the limit groove,
wherein the guide portion comprises a guide plane which is tangent to a peripheral surface of the linkage wheel, the suspension portion moving along the guide plane, the limit groove being disposed at an end of the guide plane.

13-14. (canceled)

15. The refrigerator according to claim 12, wherein the suspension portion comprises a snapping-embedding member that matches with a shape of the limit groove, the snapping-embedding member being connected to the connecting portion, wherein the snapping-embedding member is a snapping-embedding head that is elastically deformable and is deformable to be embedded in or disengaged from a notch of the limit groove, wherein the snapping-embedding head is an elastically deformable hollow cylindrical member.

16-17. (canceled)

18. The refrigerator according to claim 12, wherein the connecting portion is an elastically deformable connecting arm.

19. The refrigerator according to claim 1, further comprising a door ejection mechanism, wherein the door ejection mechanism is disposed on the linkage wheel, and wherein in a condition that the linkage wheel rotates, the door ejection mechanism is able to eject the door body open, wherein the door ion mechanism comprises a door ejection portion which is disposed on and protruded from the linkage wheel, and wherein in a condition that the linkage wheel rotates, the doors ejection portion extends out of the box body to eject the door body open.

20. (canceled)

21. The refrigerator according to claim 19 , wherein the door ejection portion has an exterior surface, and wherein in a condition that the door body closes the box body, the exterior surface is flush with an opening of the box body.

22. The refrigerator according to claim 1, further comprising a door ejection mechanism, wherein the door ejection mechanism comprises a door ejection member which is movably disposed on the box body, and wherein in a condition that the linkage wheel rotates, an abutting-holding portion formed on the linkage wheel is able to rotate with the linkage wheel to push the door ejection member to move relative to the box body, to make the door ejection member to eject the door body open.

23. The refrigerator according to claim 22, wherein the abutting-holding portion has a door ejection surface, and wherein in a condition that the abutting-holding portion rotates with the linkage wheel, a door ejection surface abuts against and holds the door ejection member to be able to push the door ejection member to move relative to the box body, to make the door ejection member to eject the door body open.

24. The refrigerator according to claim 23, wherein the door ejection surface gradually extends in a direction away from a rotation center of the linkage wheel.

25. The refrigerator according to claim 23, further comprising an elastic reset member, wherein the elastic reset member is connected between the box body and the door ejection member, and wherein in a condition that the door ejection member is out of cooperation with the door ejection surface, the elastic reset member is able to drive the door ejection member to follow a movement of a peripheral surface of the linkage wheel to reset the door ejection member.

26. The refrigerator according to claim 22, wherein a mounting groove is disposed on the box body, the door ejection member being movably disposed in the mounting groove.
